(19) United States
(12) Patent Application Publication
(10) Pub. No.: US 2016/0054037 A1
(43) Pub. Date: Feb. 25, 2016

(54) Refrigeration Device Comprising an Evaporator

(71) Applicant: BSH HAUSGERÄTE GMBH, München (DE)

(72) Inventors: REINHARD MEHNER, DOEBELN (DE); DANIEL MICKO, ULM (DE); HOLGER MOCH, GIENGEN (DE); BERND SCHLOEGEL, GERSTETTEN (DE); ANDREAS VOGL, HAUNSHEIM (DE)

(21) Appl. No.: 14/782,948

(22) PCT Filed: Apr. 3, 2014
(86) PCT No.: PCT/EP2014/056691

§ 371 Date: Oct. 7, 2015

(30) Foreign Application Priority Data
Apr. 9, 2013 (DE) 10 2013 206 203.6

(51) Int. Cl. F25B 39/00; B23P 15/26

(52) U.S. Cl. CPC F25B 39/00; B23P 15/26; F25B 39/02

(57) ABSTRACT

A refrigeration device has an evaporator for evaporating a refrigerant. The evaporator includes an inlet pipe for the admission of the refrigerant, in which inlet pipe there is formed a pipe region, which has a first flow cross section, and a constriction region, which has a second flow cross section that is smaller than the first flow cross section. A method is also described for producing such an evaporator.

The present invention relates to a refrigeration appliance having an evaporator.

At the point where refrigerant is injected into an evaporator of a refrigeration appliance refrigerant is injected by a throttle device into an inlet pipe of the evaporator, said inlet pipe having a much larger internal diameter than at the opening of the throttle device. As a result the flow of refrigerant produces noise.

It is the object of the invention to specify a refrigeration appliance, in which the noise that is produced when a refrigerant is injected into an evaporator is reduced.

This object is achieved by subject matter with the features set out in the independent claims. Advantageous embodiments of the invention are the subject matter of the figures, the description and the dependent claims.

According to one aspect of the invention the object is achieved by a refrigeration appliance having an evaporator for evaporating a refrigerant, wherein the evaporator comprises an inlet pipe for admitting the refrigerant, in which inlet pipe a pipe region is formed with a first flow cross section and a constriction region is formed with a second flow cross section, which is smaller than the first flow cross section. This has the technical advantage for example that the flow noise at the point of injection from the throttle device into the evaporator is reduced. This changes the geometry of the evaporator to produce improved noise characteristics due to the change of flow.

A refrigeration appliance refers in particular to a domestic refrigeration appliance, in other words a refrigeration appliance used for domestic management in a domestic situation or in the catering sector, serving in particular to store food and/or beverages at defined temperatures, for example a refrigerator, a freezer cabinet, a combined refrigerator/freezer, a chest freezer or a wine chiller cabinet.

In one advantageous embodiment of the refrigeration appliance the constriction region is formed by at least one concave inward curvature of a pipe wall of the inlet pipe. This has the technical advantage for example that the rigidity and bending moment of the inlet pipe are maintained by the concave inward curvature.

In a further advantageous embodiment of the refrigeration appliance the inlet pipe has a circular cross section. This has the technical advantage for example that the inlet pipe can be produced with little material outlay and a large flow cross section.

In a further advantageous embodiment of the refrigeration appliance the constriction region forms a chamber in the inlet pipe. This has the technical advantage for example that the chamber forms a buffer space for the inflowing refrigerant and the resulting noise is further reduced.

In a further advantageous embodiment of the refrigeration appliance the inlet pipe comprises a number of constriction regions. This has the technical advantage for example that the resulting noise is even further reduced.

In a further advantageous embodiment of the refrigeration appliance a pipe region is arranged between two constriction regions, said pipe region having a constant, first flow cross section over a predetermined length. This has the technical advantage for example that the flow is stabilized along the length with the constant flow cross section.

In a further advantageous embodiment of the refrigeration appliance the constriction region has a circular, rectangular or star-shaped cross section. This has the technical advantage for example that the constriction region with reduced flow cross section can be produced in a simple manner.

In a further advantageous embodiment of the refrigeration appliance the inlet pipe comprises a conical connecting region for a capillary tube. This has the technical advantage for example that the noise characteristics of the evaporator are improved even further.

In a further advantageous embodiment of the refrigeration appliance the constriction region is arranged directly after the connecting region. This has the technical advantage for example that

In a further advantageous embodiment of the refrigeration appliance the constriction region is arranged at a distance of less than 50 mm after one end of a capillary tube. This also has the technical advantage for example that the noise characteristics are improved even further.

In a further advantageous embodiment of the refrigeration appliance the ratio of the first flow cross section to the second flow cross section is greater than 5:1. This has the technical advantage for example that flow conditions that produce particularly little noise are achieved in the interior of the evaporator.

According to a second aspect of the invention the object is achieved by a method for producing an evaporator for a refrigeration appliance, comprising an inlet pipe for admitting a refrigerant, with the steps of inserting a mandrel, which predetermines the profile of a second flow cross section, into the inlet pipe with a first flow cross section; compressing the inlet pipe to the second flow cross section predetermined by the mandrel, in order to produce a constriction region; and removing the mandrel from the inlet pipe. This has the technical advantage for example that the evaporator can be produced in a particularly simple manner.

If support were not provided by the mandrel within the inlet pipe, there would be a risk of the inlet pipe closing up completely during shaping. It would also not be possible then to comply with predetermined manufacturing tolerances. With the aid of the mandrel it is possible to produce the cross sectional area in the constriction region reliably in the required tolerance range. With a long mandrel it is also possible to introduce a number of shapes one after the other over a longer pipe length.

In one advantageous embodiment of the method the compression of the inlet pipe is performed using a forming insert of a tool that can be displaced radially in relation to the center of the inlet pipe. This has the technical advantage for example that the constriction region of the inlet pipe can be formed in a technically simple manner.

In a further advantageous embodiment of the method a concave inward curvature is produced in a pipe wall of the inlet pipe by a shaping segment of the forming insert during compression. This has the technical advantage for example that the rigidity and bending moment of the inlet pipe are maintained by the concave inward curvature.

In a further advantageous embodiment of the method the shaping segment is formed by a roller, which is supported in a rotatable manner on the forming insert. This has the technical advantage for example that the pipe surface of the inlet pipe is not damaged or impaired.

In a further advantageous embodiment of the method a number of concave inward curvatures are produced simultaneously by a number of shaping segments of the forming insert during compression. This has the technical advantage for example that a number of constriction regions can be produced by a single work step.

In a further advantageous embodiment of the method the mandrel has a round cross section. This has the technical advantage for example that constriction regions with a round cross section, on which the refrigerant does not eddy or become subject to turbulence, can be produced in a particularly simple manner.

In a further advantageous embodiment of the method the mandrel has a diameter of 1 mm to 2 mm. This has the technical advantage for example that the constriction region can be produced with a dimension that is particularly low-noise.

In a further advantageous embodiment of the method the compression of the inlet pipe takes place using rounded jaw elements, which are pressed perpendicular to the longitudinal axis of the inlet pipe. This has the technical advantage for example that the constriction region can be formed quickly and without kinks.

In a further advantageous embodiment of the method the jaw elements comprise a semi-circular cutout for compressing the inlet pipe. This has the technical advantage for example that the inlet pipe of the evaporator is formed in the constriction region by the jaw elements to correspond to the inserted mandrel.

Exemplary embodiments of the invention are illustrated in the drawings and described in more detail in the following.

In the drawings:

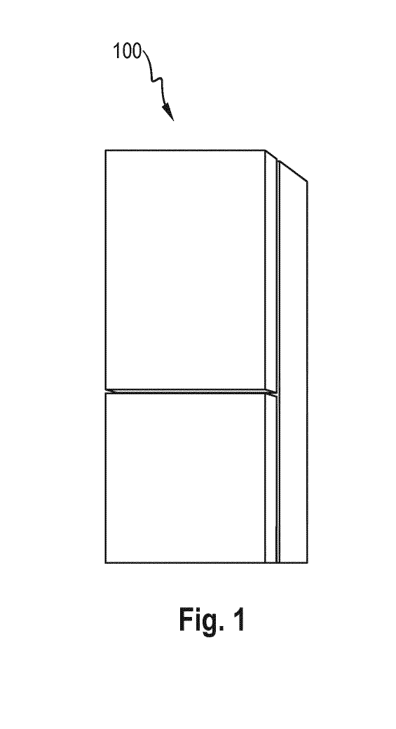

FIG. 1 shows a schematic view of a refrigeration appliance;

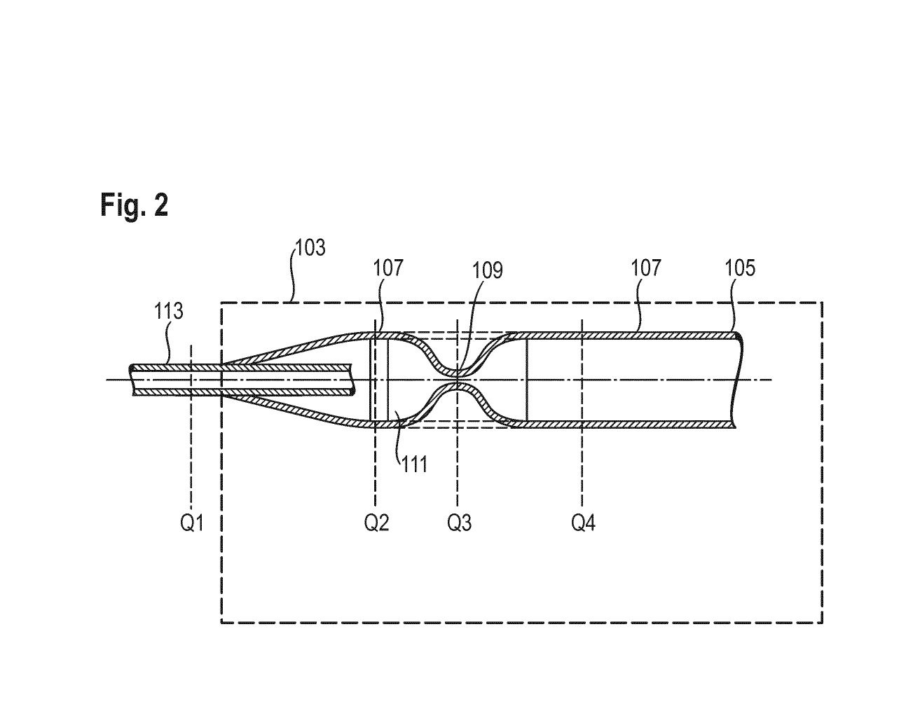

FIG. 2 shows a schematic view of an evaporator with a first embodiment of an inlet pipe;

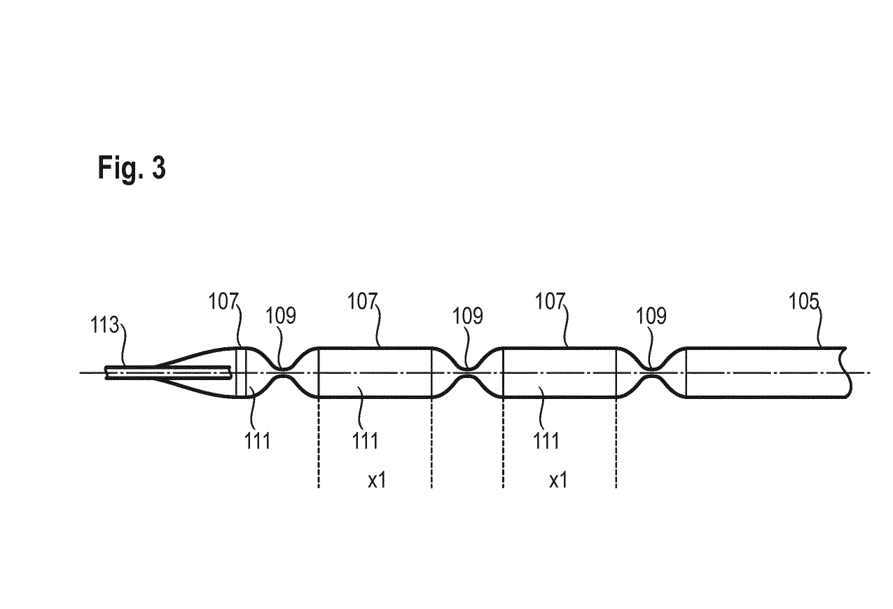

FIG. 3 shows a schematic view of a further embodiment of the inlet pipe;

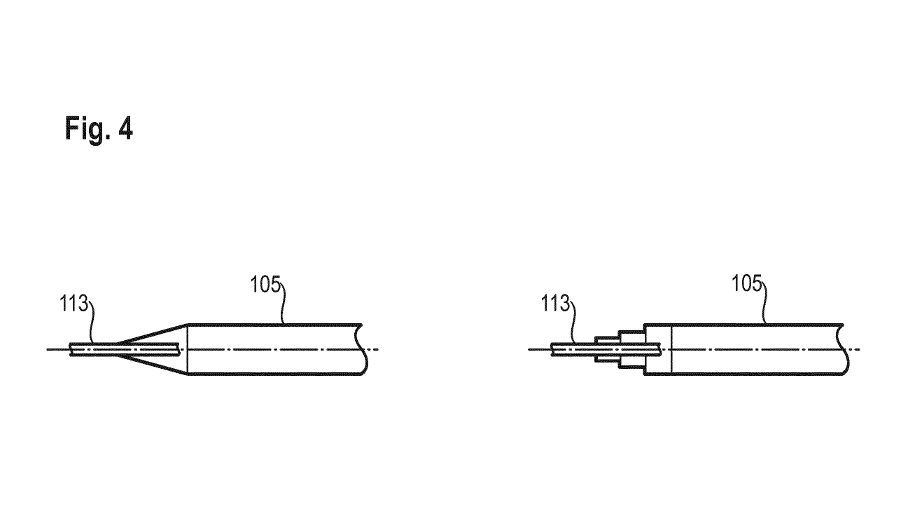

FIG. 4 shows a connecting region of the inlet pipe;

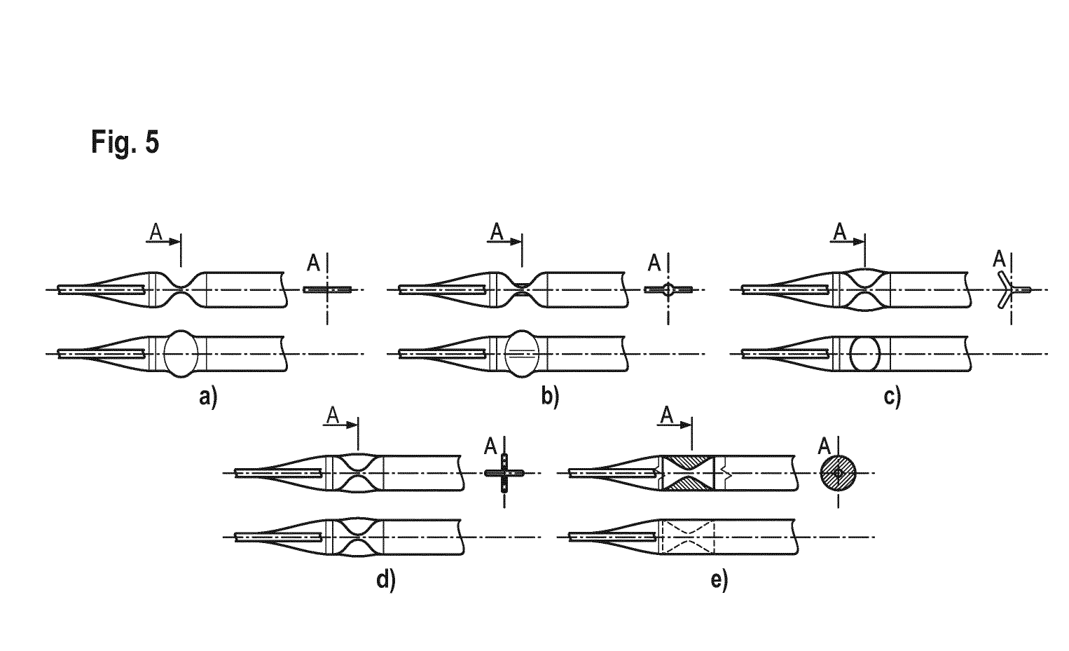

FIG. 5 shows different embodiments of a number of constriction regions;

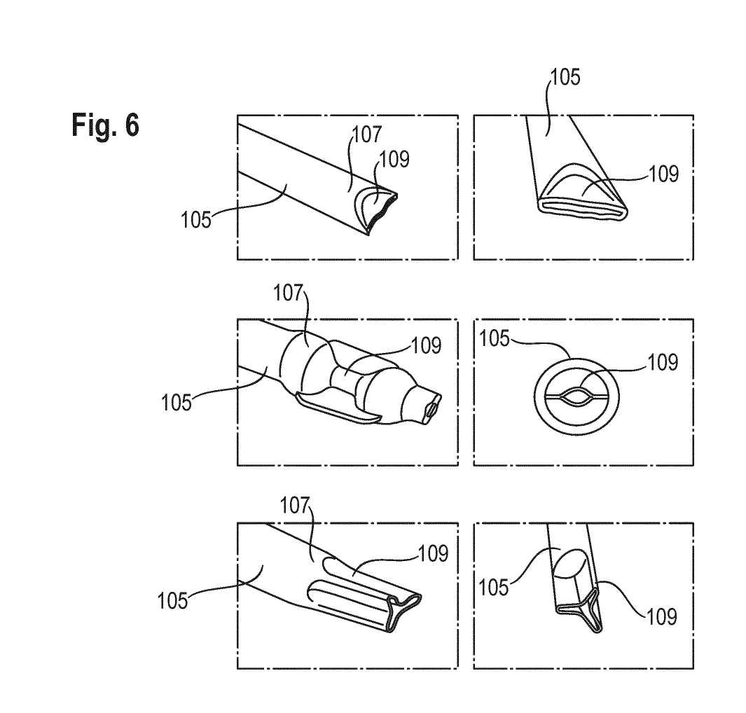

FIG. 6 shows different embodiments of a number of constriction regions;

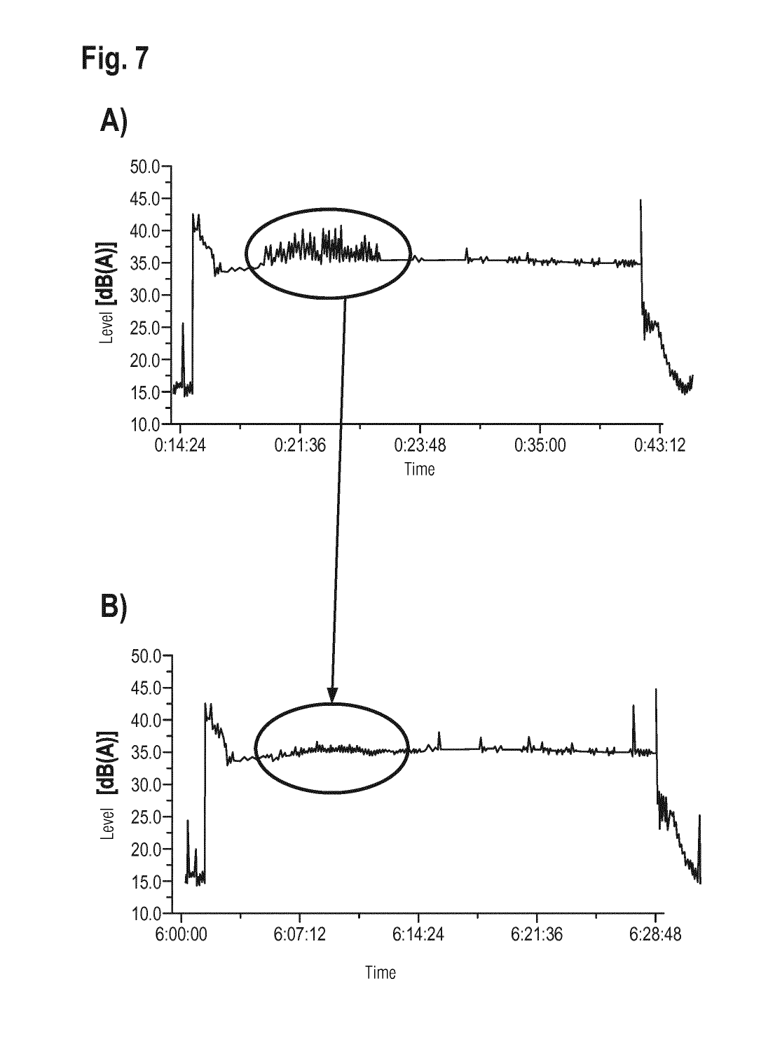

FIG. 7 shows diagrams of the noise resulting from the evaporator with and without constriction region;

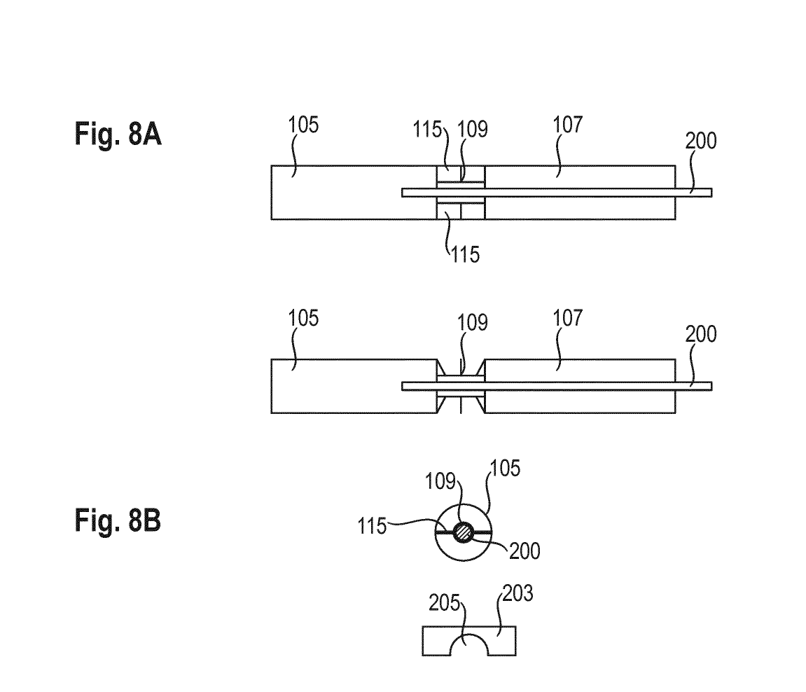

FIG. 8A shows a method for producing the evaporator for the refrigeration appliance;

FIG. 8B shows a cross sectional view of a constriction region; and

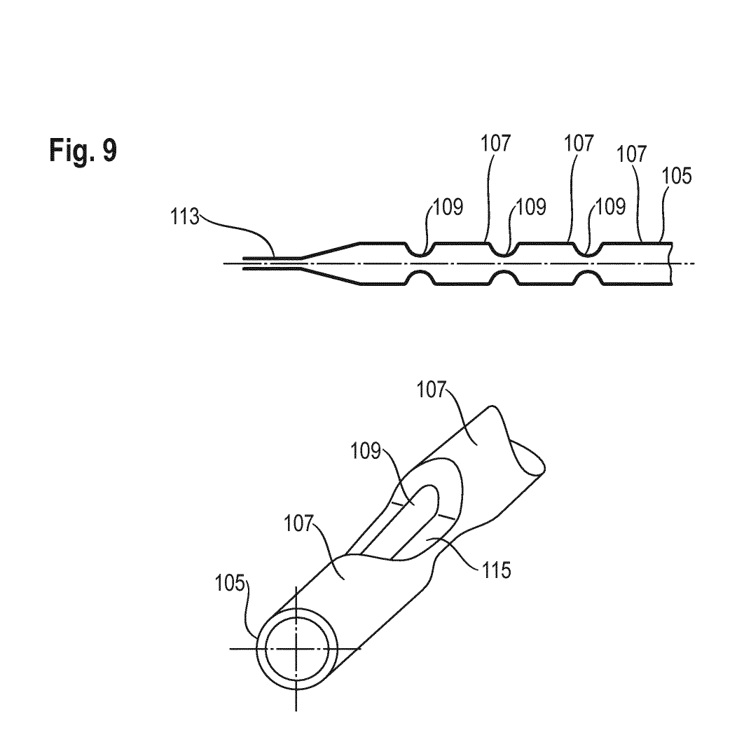

FIG. 9 shows the inlet pipe after the shaping process;

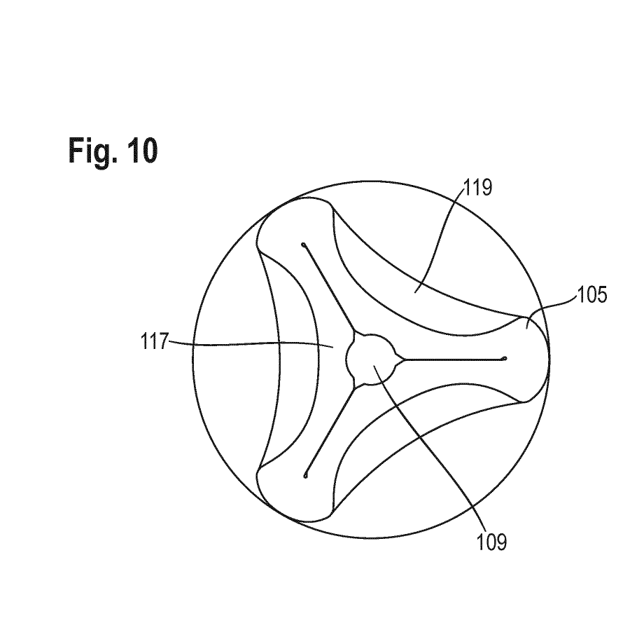

FIG. 10 shows a cross sectional view of a further constriction region;

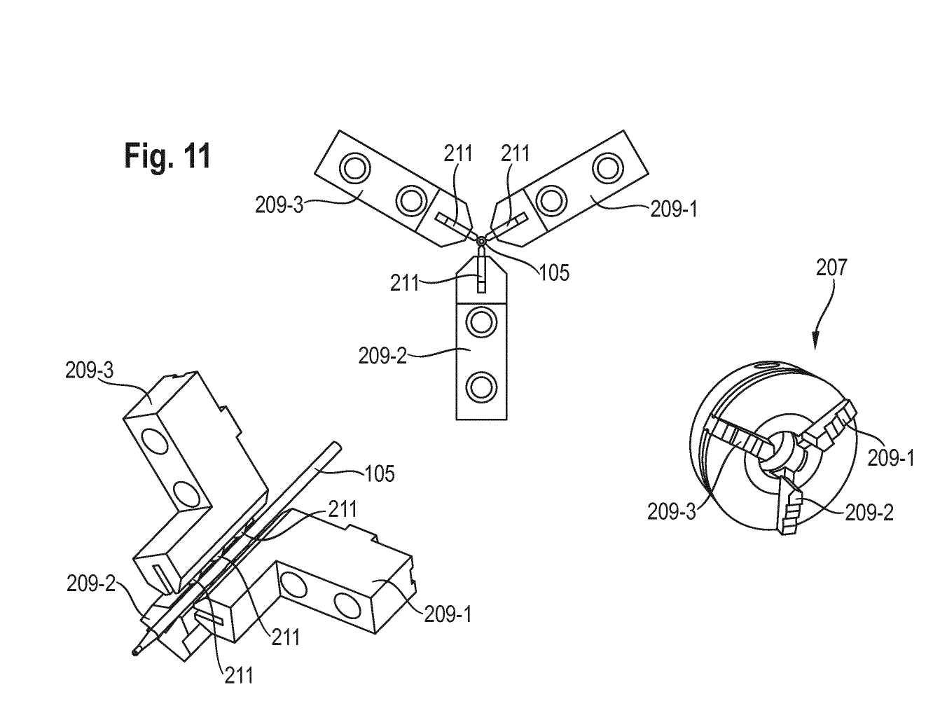

FIG. 11 shows a tool for producing the inlet pipe with the constriction region;

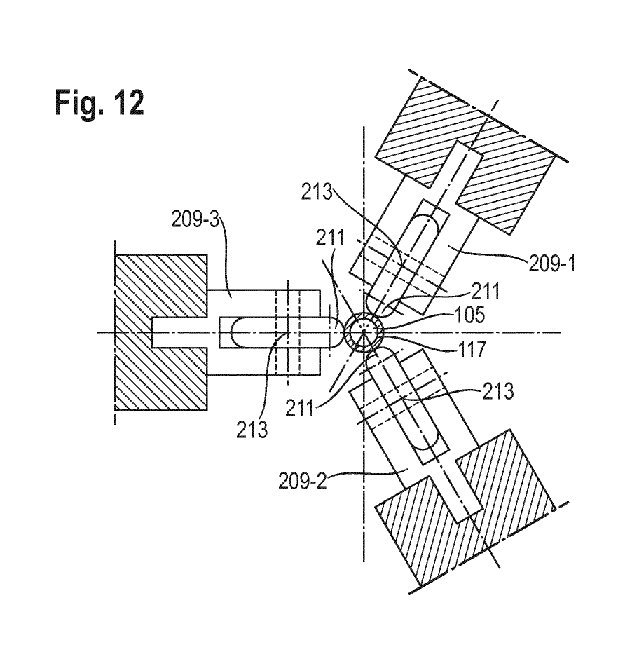

FIG. 12 shows a cross sectional view of the tool for producing the inlet pipe;

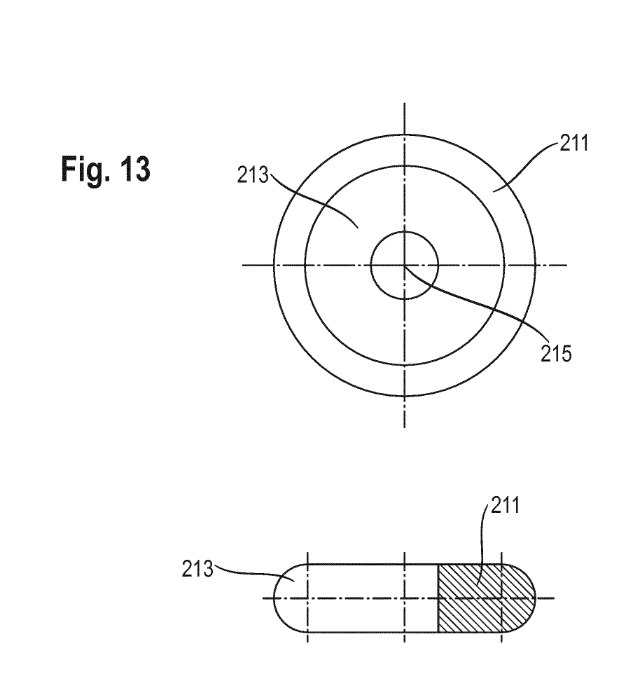

FIG. 13 shows a shaping segment of the tool;

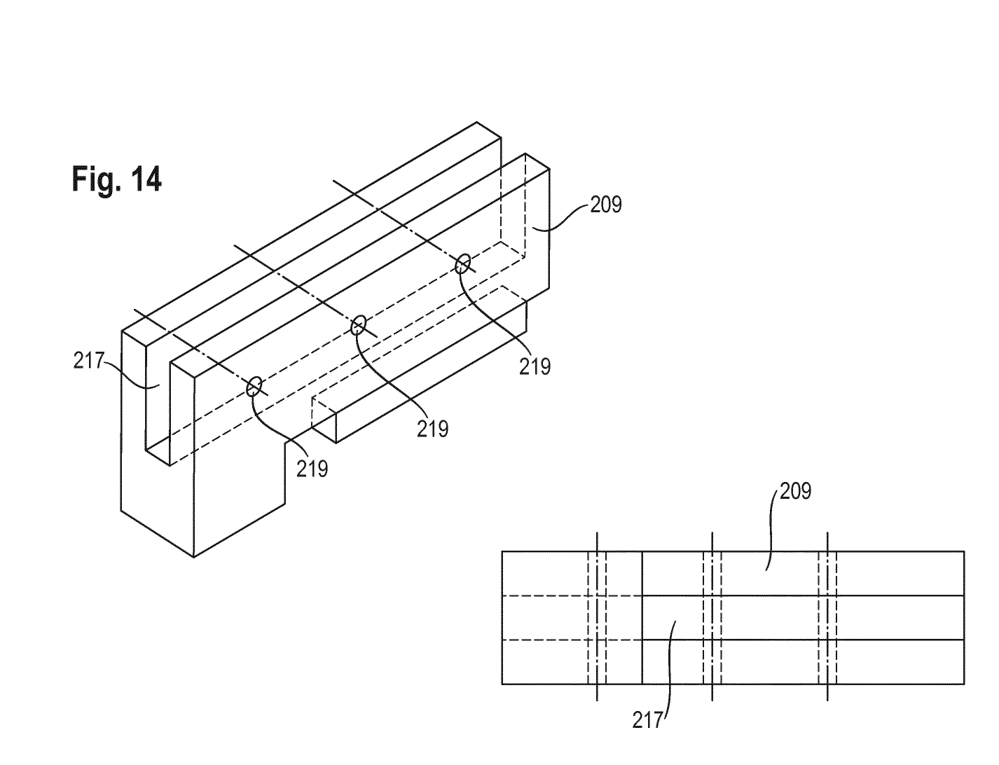

FIG. 14 shows a forming insert of the tool; and

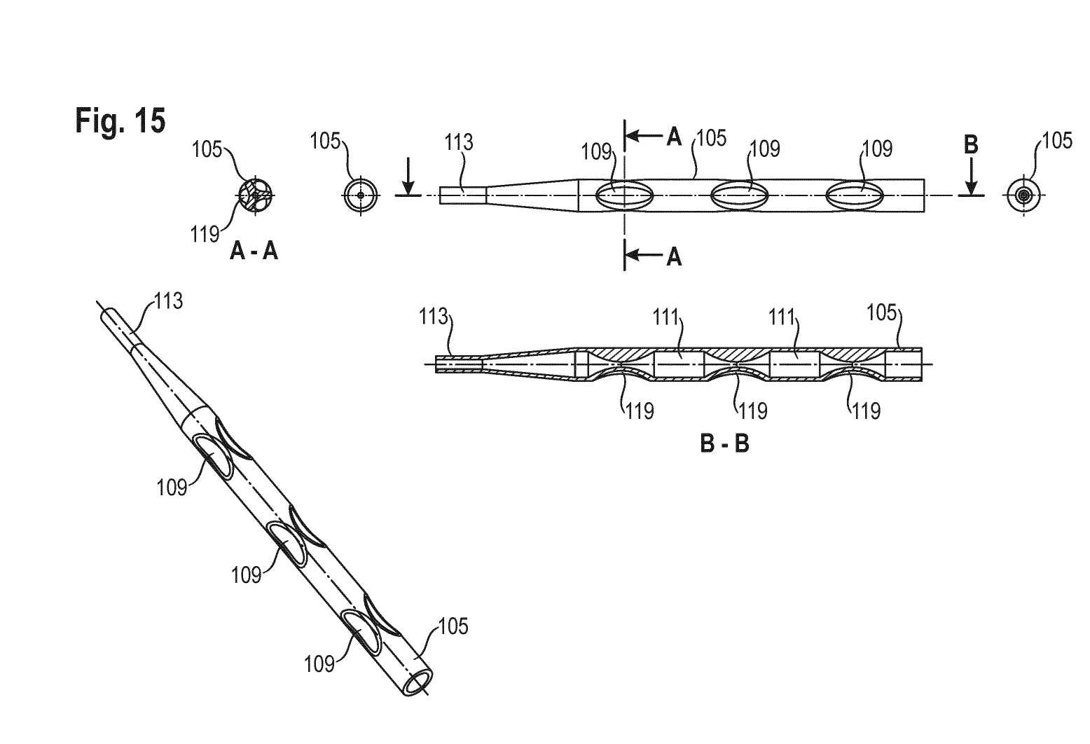

FIG. 15 shows views of an inlet pipe produced using the tool.

FIG. 1 shows a refrigeration appliance 100 in the form of a refrigerator, with an upper refrigerator door and a lower refrigerator door. The refrigerator serves for example to chill food and comprises a refrigerant circuit with an evaporator, a compressor, a condenser and a throttle device. The evaporator is a heat exchanger, in which after expansion the liquid refrigerant is evaporated by the absorption of heat from the medium to be cooled, in other words the air in the interior of the refrigerator.

The compressor is a mechanically operated component, which takes in refrigerant vapor from the evaporator and ejects it at a higher pressure to the condenser. The condenser is a heat exchanger, in which after compression the evaporated refrigerant is condensed by the emission of heat to an external cooling medium, in other words the ambient air. The throttle device is an apparatus for constantly reducing pressure by cross section constriction.

The refrigerant is a fluid, which is used to transfer heat in the cold-generating system, absorbing heat when the fluid is at low temperatures and low pressure and emitting heat when the fluid is at higher temperature and higher pressure, with changes of state of the fluid generally being included.

FIG. 2 shows a schematic view of an evaporator 103 with a first embodiment of an inlet pipe 105. At the injection point the refrigerant is injected by the throttle device or capillary tube 113 into an inlet pipe 105 with a much larger internal diameter than at the opening of the capillary tube 113. This produces flow noise.

The evaporator 103 therefore comprises a pipe region 107 with a first flow cross section and a constriction region 109 with a second flow cross section, which is smaller than the first flow cross section. The constriction region 109 changes the geometry of the evaporator in order to change the flow of the refrigerant in such a manner that improved noise characteristics result. To this end the internal cross section of the evaporator 103 is reduced once or a number of times so that one or more chambers 111 are formed. The constriction regions 109 here can be arranged in such a manner that the dimensions of the chambers, for example length, width or volume, differ.

The principle of reducing admission noise consists of reducing the flow cross section in the inlet pipe 105 at the transition from the pipe region 107 to the constriction region 109 and subsequent enlarging of the flow cross section at the transition from the constriction region 109 to the pipe region 107. The ratio of the flow cross section in the pipe region 107 to the flow cross section in the constriction region 109 is for example greater than 5:1. Generally this ratio can be different in each of the constriction regions 109.

The inlet pipe 105 has four different cross sectional areas. At the admission point of the refrigerant at the capillary tube 113 the cross sectional area is Q1. At the point where the capillary tube 113 ends the cross sectional area of the inlet pipe is Q2. In the constriction region 109 the reduced cross sectional area is Q3. In the adjoining inlet pipe 105 the cross sectional area is Q4. The cross sectional area Q4 can be different from the cross sectional area Q2 here.

Between the cross sectional area Q1 and cross sectional area Q2 the cross sectional area increases from the cross sectional area of the capillary tube 113 up to the inlet pipe 105. Between the cross sectional area Q2 and cross sectional area Q3 the cross sectional area decreases from the cross sectional area of the inlet pipe 105, at which the capillary tube 113 ends, toward the cross sectional area of the constriction region 109 (in proximity to the end of the capillary tube 113, in proximity to the end of the evaporator pipe). Between the cross sectional area Q3 and cross sectional area Q4 the cross sectional area of the constriction region 109 increases toward the inlet pipe 105.

The constriction region 109 is arranged in proximity to the end of the capillary tube 113. For example the constriction region 109 is at a distance of less than 50 mm behind the capillary tube 113. The constriction region 109 preferably lies at a distance of 10 mm behind the capillary tube 113. A short distance between the capillary tube 113 and the constriction region 109 is particularly favorable for noise characteristics.

FIG. 3 shows a schematic cross sectional view of a further embodiment of the inlet pipe 103. In this embodiment the inlet pipe 103 comprises three constriction regions 109, so that three chambers 111 are formed, into which the refrigerant flows. The chambers have a pipe region 109, which has a constant flow cross section over a predetermined length x1. This embodiment improves the noise characteristics still further. The shape and dimensions of the constriction regions 109 in the inlet pipe 105 can generally be different from one another. Also the distances between constriction regions 109 can be different. The constriction regions 109 can have a rectangular cross section, produced by compressing the sides of the inlet pipe 105. This reduces a high sound pressure level when the refrigerant is being injected in.

FIG. 4 shows a connecting region of the inlet pipe 105 for a capillary tube 113. The admission point for the refrigerant at the connecting region forms the transition between the high-pressure segment and the low-pressure segment of the refrigerant circuit. There is a sudden change in the flow cross section from the capillary tube 113 to the larger inlet pipe 105 of the evaporator 103 at this point. The spreading out of the refrigerant at this point is accompanied by admission noise. In order to improve the noise characteristics further, the cross section of the connecting region of the inlet pipe 105 is increasingly enlarged.

The inlet pipe 105 widens conically or in a stepped manner for example in the connecting region. The cross section of the inlet pipe 105 is therefore enlarged slowly after injection of the refrigerant until the actual flow cross section of the inlet pipe 105 is reached. This further reduces flow noise at the injection point from the throttle device or capillary tube into the evaporator.

FIG. 5 shows a number of constriction regions 109. A rectangular cross section is shown in part a). A circular cross section is shown in part b). A star-shaped cross section with three points is shown in part c). A rectangular cross section with four corners is shown in part d). A throttle unit for insertion into the inlet pipe 105, which comprises the constriction region 109, is shown in part e).

FIG. 6 again shows different embodiments of a number of constriction regions 109. The flow cross section of the constriction region 109 can be configured differently. For example the flow cross section can have a rectangular, circular or star-shaped form.

FIG. 7 shows diagrams of the noise resulting from the evaporator 103 with and without constriction region. The diagram A) shows the noise resulting from the evaporator 103 during admission of the refrigerant, when there is no constriction region 109 formed in the inlet pipe 105. When the refrigerant is admitted a noise then results as shown by an ellipse in the diagram.

When at least one constriction region 109 is formed in the inlet pipe 105, reducing the flow cross section compared with the remainder of the inlet pipe 105, the noise during admission of the refrigerant into the evaporator 103 decreases. The constriction region 109 reduces the characteristic injection noise to a minimum. This is shown in diagram B).

FIG. 8A shows a method for producing the evaporator 103 for the refrigeration appliance 100. To this end it shows a plan view and side view of the inlet pipe 105 with the mandrel 200 inserted. In a first step a mandrel 200, the external dimensions of which define the shape of the constriction region 109, is inserted into the inlet pipe 105. In a second step the inlet pipe 105 is compressed along the mandrel 200 to the flow cross section predetermined by the mandrel 200 to produce the constriction region 109. In a third step the mandrel 200 is removed from the inlet pipe 105.

FIG. 8B shows a cross sectional view of the constriction region 109 with the mandrel 200 inserted. The mandrel 200 can be circular in cross section, so that a round flow cross section is shaped in the constriction region 109. Compression takes place for example using shaped jaw elements 203 acting on the round mandrel 200, these having a semicircular cutout 205. This produces lateral areas 115 to the left and right of the constriction region 109, providing additional stability for the constriction region 109. A round cross section results, with a diameter of 1.7 mm for example. A bead is also produced, which increases the strength of the constriction region 109 so there is no need for an additional stiffening part.

However mandrels with other shapes can also generally be used, producing other flow cross sections in the constriction region. For example a mandrel 200 with a rectangular or square profile can be used, producing a rectangular or square flow cross section, of for example 7 mm×0.3 mm. Rounded, straight jaw elements can then be used for shaping, being pressed perpendicular to the pipe axis. The inlet pipe 105 can be bent and kinked very easily in the region of the shaping.

FIG. 9 shows the inlet pipe 105 after the shaping process. Formed in the center of the inlet pipe 105 are one or more constriction regions 109, which comprise the lateral areas 115.

The evaporator 103 causes injection noise in the refrigeration appliance to be reduced. The evaporator 103 can be produced in a simple manner. The number of constriction regions 109 and their form are variable.

FIG. 10 shows a cross sectional view of a further constriction region 109 of the inlet pipe 105. The constriction region 109 is produced by shaping a pipe wall 117 of the inlet pipe 105 in an inward manner radially in three positions using a tool. This produces concave inward curvatures 119 on the outside of the constriction region 109, separated by 120° from one another in a circumferential direction.

FIG. 11 shows a tool 207 for producing the inlet pipe 105, with the constriction region 109. The tool 207 comprises three forming inserts 209-1, 209-2, 209-3, which are pressed onto the inlet pipe 105 by the tool 207 in a radial direction to produce the concave inward curvatures 119. The lateral deformation of the inlet pipe 105 produces the constriction region 109 in the interior of the inlet pipe 105. At its tip each of the forming inserts 209-1, 209-2, 209-3 comprises three roller-shaped, spherical, extended spherical or zeppelin-shaped shaping segments 211, which press against the pipe wall 117 as the inward curvatures 119 are produced.

It is thus possible simultaneously to produce three inward curvatures by pressing a forming insert 209-1, 209-2, 209-3 once. The internal cross section of the constriction region 109 is defined by the inserted mandrel 200. This means that the pipe tolerance does not influence the internal diameter of the constriction region 109. After the forming process the mandrel 200 is removed from the formed inlet pipe.

The tool 207 produces a cross sectional change based on a mechanical forming process, in that the forming inserts 209-1, 209-2, 209-3 are pressed using force, pressure or impact. The shaping segments 211 are each inserted in a cutout in the forming inserts 209-1, 209-2, 209-3.

The forming inserts 209-1, 209-2, 209-3 are guided in a radial direction by the tool 207. The number of forming inserts is generally not limited to three. Two or four forming inserts can be used in the same way. The deformations produced by the tool 207 bring about noise optimization as a result of deformation at the refrigerant pipe in the region of the injection point. Shaping or forming operations can be performed once or a number of times one after the other in line if required. Shaping can take place directly on or in the injection region or other points of the inlet pipe 105.

FIG. 12 shows a cross sectional view of the tool 207 for producing the inlet pipe 105. The shaping segments 211 of the radially displaceable forming inserts 209-1, 209-2, 209-3 are formed by rollers 213, which have a semi-circular external profile in cross section. The rollers 213 are supported in a rotatable manner in the respective forming inserts 209-1, 209-2, 209-3. The rollers 213 produce a corresponding inward curvature 119 during forming.

FIG. 13 shows a shaping segment 211 formed by a roller 213. The roller 213 comprises an opening 215, through which a pin is pushed to fasten the roller 213 to the forming insert 209-1, 209-2, 209-3. The roller 213 is made of a hard metal for example, in order to minimize tool wear during shaping.

FIG. 14 shows an L-shaped forming insert 209 of the tool 207, serving as a roller holder. The forming insert 209 comprises a rectangular cutout 217, which serves for the insertion of the rollers 213 as the shaping segment 211. The rollers 213 are fastened by pins to the respective positions in the openings 219. The forming insert 209 serves as a triple chuck and rail for the rollers 213. The rollers 213 produce the corresponding inward curvatures 119 in the pipe wall 117 as the shaping segment 211.

FIG. 15 shows views of an inlet pipe 105 produced using the tool 207. The geometric form and shape of the tool 207 is significant for rigidity and acoustic improvement. As a result of the forming of the rollers 213 the inlet pipe 105 comprises constriction regions 109 that are circular in cross section. A chamber 111 results between two constriction regions 109 respectively.

The geometric shape of the inlet pipe 105 increases the rigidity and bending moment. Kinks in the inlet pipe 105 or cross sectional changes to the constriction region 109 during the subsequent assembly process are prevented. Noise production and acoustics are reduced. The tool 207 brings about an acoustic improvement for mass production, an increase in rigidity in the event of bending stress and process reliability when producing the geometry.

The method for producing the evaporator does not damage or impair the pipe surface of the inlet pipe 105. Leakage during the forming process, for example due to cracks, is therefore excluded.

All the features explained and illustrated in conjunction with individual embodiments of the invention can be provided in different combinations in the inventive subject matter in order to achieve their advantageous effects simultaneously.

The scope of protection of the present invention is defined by the claims and is not restricted by the features explained in the description or illustrated in the figures.

### LIST OF REFERENCE CHARACTERS

100 Refrigeration appliance
103 Evaporator
105 Inlet pipe
107 Pipe region
109 Constriction region
111 Chamber
113 Capillary tube
115 Lateral area
117 Pipe wall
119 Inward curvature
200 Mandrel
203 Jaw elements
205 Cutout
207 Tool
209 Forming insert
211 Shaping segment
213 Roller
215 Opening
217 Cutout
219 Opening

1-15. (canceled)

16. A refrigeration appliance, comprising:
an evaporator for evaporating a refrigerant, said evaporator including an inlet pipe for admitting the refrigerant;
said inlet pipe having a pipe wall and having a pipe region formed with a first flow cross section and a constriction region formed with a second flow cross section smaller than said first flow cross section; and
said constriction region being formed by a plurality of concave inward curvatures of said pipe wall of said inlet pipe.

17. The refrigeration appliance according to claim 16, wherein said constriction region forms a chamber in said inlet pipe.

18. The refrigeration appliance according to claim 16, wherein said constriction region is one of a plurality of constriction regions formed in said inlet pipe.

19. The refrigeration appliance according to claim 18, wherein said pipe region is arranged between two said constriction regions, said pipe region having a constant, first flow cross section over a predetermined length.

20. The refrigeration appliance according to claim 16, wherein said constriction region has a cross-section selected from the group consisting of a circular cross-section, a rectangular cross-section and a star-shaped cross section.

21. The refrigeration appliance according to claim 16, wherein said inlet pipe comprises a conical connecting region for a capillary tube.

22. The refrigeration appliance according to claim 21, wherein said constriction region is arranged directly following said connecting.

23. The refrigeration appliance according to claim 16, wherein said constriction region is arranged at a distance of less than 50 mm following one end of a capillary tube.

24. The refrigeration appliance according to claim 16, wherein a ratio of said first flow cross section to said second flow cross section is greater than 5:1.

25. A method for producing an evaporator for a refrigeration appliance, the evaporator having an inlet pipe for admitting a refrigerant, the method comprising the following steps:
providing an inlet pipe with a first flow cross section;
inserting a mandrel, which predetermines a profile of a second flow cross section, into the inlet pipe;
compressing the inlet pipe to the second flow cross section as predetermined by the mandrel, in order to produce a constriction region in the inlet pipe; and
removing the mandrel from the inlet pipe.

26. The method according to claim 25, wherein the step of compressing the inlet pipe comprises using a forming insert of a tool that can be displaced radially in relation to a center of the inlet pipe.

27. The method according to claim 26, which comprises forming concave inward curvatures in a pipe wall of the inlet pipe by a shaping segment of the forming insert during the compressing step.

28. The method according to claim 27, wherein the shaping segment is a roller rotatably supported on the forming insert.

29. The method according to claim 26, wherein the compressing step comprises simultaneously producing a plurality of concave inward curvatures by a plurality of shaping segments of the forming insert.
